(19) United States
(12) Patent Application Publication
(10) Pub. No.: US 2008/0250105 A1
(43) Pub. Date: Oct. 9, 2008

(54) Method for enabling a user to vote for a document stored within a database

(75) Inventor: Dan Grois, Omer (IL)

Correspondence Address: Dan Grois, 13A Adad street, P. O. Box 585, Omer, 84965, IL

(73) Assignee: Dan Grois, Omer (IL)

(21) Appl. No.: 12/156,589

(22) Filed: Jun. 4, 2008

(30) Foreign Application Priority Data
Dec. 13, 2005 (IL) 172551

(51) Int. Cl. G06F 15/16; G06F 17/30; G06F 7/06

(52) U.S. Cl. 709/203; 707/5; 707/E17.014

(57) ABSTRACT

The present invention relates to a method and computer readable recording medium of enabling voting for a document stored within a database over a data network, comprising: (a) receiving user's search query; (b) providing a search results list, according to said search query, wherein said search results list comprises at least one document; (c) providing one or more categorized voting scales for said at least one document, said one or more voting scales enabling selecting corresponding one or more categorized evaluations for said at least document, thereby enabling providing one or more categorized votes for said at least one document; and (d) submitting said one or more categorized evaluations.

### FIELD OF THE INVENTION

The present invention relates to search engines. More particularly, the present invention relates to a method for assigning one or more categorized scores to each document stored within a database over a data network, such as the Internet.

### BACKGROUND OF THE INVENTION

For the last decade, the Internet has grown significantly due to the dramatic technology developments. Surfing the Internet has become a very simple and inexpensive task, which can be afforded by everyone. Due to the ISDN® (Integrated Services Digital Networks) and ADSL® (Asymmetric Digital Subscriber Line®) technology, people surf the World Wide Web (WWW) with the speed of up to 12 Mbits per second, which allow them to obtain search results of their queries for less than a second. A number of new Web sites over the Internet, which go online every month, has also significantly increased over the last decade. Each of main search engines over the World Wide Web crawls nowadays billions of documents. However, all search engines implemented on the prior art technology have not been originally developed for handling and searching such huge amount of information, and therefore over the years they have failed to provide efficient search results for users' queries. Without providing an efficient search engine in the near future, people soon will not be able to find anything from among billions and trillions of documents.

One example of the prior art solution for handling documents is U.S. Pat. No. 6,285,999, which presents a method for assigning importance ranks to nodes in a linked database. The rank assigned to a document is calculated from the ranks of documents citing it. The rank of a document is calculated from a constant, representing the probability that a browser through the database will randomly jump to the document. However, according to U.S. Pat. No. 6,285,999 a rank of a linked document is calculated entirely basing on a rank of a linking document, without considering the relevance of said linking document to said linked document and to the parameters of a link (such as link anchor text, link category, link wording, link URL (Uniform Resource Locator), etc.) from said linking document to said linked document. This means that, for example, if a pharmaceutical site “A”, having a rank of 5, links only to a sport site “B”, then said sport site “B” also obtains a rank of 5. However, there can be absolutely no logical connection between said pharmaceutical and sport sites. As a result, the rank of said sport site “B” can be greater than the rank of another sport site “C”, for example. In turn, a user while searching the Web for the sport sites would find the sport site “B” rather than the sport site “C”, in spite of the fact that said sport site “C” can be more relevant for his search query than said sport site “B”. Many Web site webmasters around the world take an advantage of these prior art drawbacks and optimize their Web sites by purchasing links to their Web sites from highly ranked Web pages, obtaining by this way a higher page rank. However, their Web sites, while having the high page rank, actually do not provide contents being appropriate to their said high page rank. Such Web sites “optimizations” lead to users misleading and finally would cause a complete irrelevance of the search results provided to users' queries.

Another patent application US 2005/0071741 discloses a system which identifies a document and obtains one or more types of history data associated with the document. The system may generate a score for the document based on one or more types of history data. US 2005/0071741 also provides a method for scoring documents. The method includes determining an age of linkage data associated with a linked document and ranking the linked document based on a decaying function of the age of the linkage data. Still another U.S. Pat. No. 6,463,430 presents an automated method of creating or updating a database of resumes and related documents. A further U.S. Pat. No. 6,738,764 discloses a method of rankling search results including producing a score for a document in view of a query. A still further U.S. Pat. No. 6,178,419 presents a method of automatically creating a database on a basis of a set of category headings, using a set of keywords provided for each category heading. The keywords are used by a processing platform to define searches to be carried out on a plurality of search engines connected to the processing platform via the Internet. A still further US 2005/0262250 discloses a modular scoring system using rank aggregation merging search results into an ordered list of results using different features of documents. However, these prior art publications are not optimized and they failed to provide efficient and effective solutions. The prior art publications do not teach scoring linked documents, according to the relevance of the parameters of each link (such as link anchor text, link category, link keywords, link URL (Uniform Resource Locator), etc.), which outcomes from each linking document to the linked document, and according to the relevance of said lining document and to said linked document. Furthermore, the above prior art publications do not teach assigning multiple scores to each linked document, according to the relevance of said linked document to a number of categories.

Still further publication, WO03/014975 presents an automatic classification method applied in two stages. In the first stage, a categorization engine classifies documents to topics. For each topic, a raw score is generated for a document and that raw score is used to determine whether the document should be at least preliminarily classified to the topic. In the second stage, for each document assigned to a topic the categorization engine generates confidence scores expressing how confident the algorithm is in this assignment. The confidence score of the assigned document is compared to the topic's threshold. However, WO03/014975 dials only with documents classification issue, and with generating a raw score for determining whether each document is correctly classified to the corresponding topic. WO03/014975 does not teach analyzing linking and/or linked documents and comparing their relevance to one or more parameters of forward links (or backlinks) from said linking documents to said linked documents, and assigning one or more categorized scores to said documents.

Therefore, there is a continuous need to provide an efficient and effective search method, which overcomes the prior art drawbacks.

It is an object of the present invention to provide a method for assigning one or more categorized scores to each document stored within a database over a data network, such as the Internet.

It is another object of the present invention to provide a computer readable recording medium for storing a set of executable instructions for assigning one or more categorized scores to each document within a plurality of documents over a data network.

It is still another object of the present invention to provide a computer readable recording medium for storing a set of executable instructions for determining assigned one or more categorized scores to each document within a plurality of documents over a data network.

It is a further object of the present invention to provide a toolbar for displaying one or more categorized scores, which are assigned to each document stored within a database over a data network.

It is still a further object of the present invention to provide a method, which is user friendly.

It is still a further object of the present invention to provide a method, which is relatively inexpensive.

Other objects and advantages of the invention will become apparent as the description proceeds.

### SUMMARY OF THE INVENTION

The present invention relates to a method and computer readable recording medium for assigning a number of categorized scores to each document stored within a database over a data network, such as the Internet.

A method for assigning one or more categorized scores to a linked document, being linked from at least one linking document, over a data network comprises: (a) determining one or more categorized scores of at least one linking document having at least one link to a linked document; (b) performing one or more of the following: (b.1.) analyzing one or more parameters of said at least one link from said at least one linking document to said linked document for determining the relevancy of said link to said linking document or to the category of said linking document; and (b.2.) analyzing one or more parameters of said linked document for determining the relevancy of said linked document to said linking document or to the category of said linking document; and (c) assigning one or more categorized scores to said linked document according to said one or more categorized scores of said at least one linking documents and according to one or more of the allowing: (c.1.) the determined relevancy of said at least one link to said at least one linking document or to its category; and (c.2.) the determined relevancy of said linked document to said at least one linking document or to its category.

Preferably, the method further comprises categorizing the at least one link according to its relevancy to one or more categories.

Preferably, the method further comprises processing the linked document according to its one or more categorized scores.

Preferably, the method further comprises initially assigning one or more categorized scores to the linked document and to the at least one lining document, and updating the corresponding one or more categorized scores of said linked document.

A computer readable recording medium for storing a set of executable instructions for assigning one or more categorized scores to each linked document within a plurality of documents over a data network, said each linked document being linked from at least one linking document comprises: (a) one or more instructions for obtaining a plurality of documents, wherein some documents are linked documents, some documents are linking documents, some linked documents are also being lining documents, and some linking documents are also being linked documents; and (b) one or more instructions for assigning one or more categorized scores to each linked document within said plurality of documents according to one or more categorized scores of at least one corresponding linking document and according to one or more of the following: (b.1.) the relevancy of a link, from said at least one corresponding linking document, to the linking document or to its category; and (b.2.) the relevancy of said each linked document to said at least one corresponding linking document or to its category.

A computer readable recording medium for storing a set of executable instructions for determining assigned one or more categorized scores to each linked document within a plurality of documents over a data network, said each linked document being linked from at least one linking document comprises: (a) one or more instructions for obtaining a plurality of documents, wherein some documents are linked documents, some documents are linking documents, some linked documents are also being linking documents, and some linking documents are also being linked documents; and (b) one or more instructions for determining one or more categorized scores assigned to each linked document within said plurality of documents.

Preferably, the computer readable recording medium further comprises one or more instructions for processing each linked document within said plurality of documents according to its one or more categorized scores.

A method for providing to a user, searching a database over a data network, one or more documents according to his search query comprises: (a) processing and categorizing user's search query; (b) processing each document within a database for determining one or more documents being relevant to said user's search query by analyzing one or more parameters of said each document; (c) determining one or more categorized scores of said one or more documents and processing said one or more documents according to their relevance to the user's query and according to their said one or more categorized scores; and (d) displaying to the user said one or more documents in a list of search results, said one or more documents organized in an order according to: (d.1.) their relevance to said user's search query or to the category of said user's search query, said relevance determined by analyzing said one or more parameters of said each document; and (d.2.) their one or more categorized scores.

Preferably, the method further comprises displaying one or more annotations of the one or more categorized scores of the displayed one or more search results.

Preferably, the method further comprises providing the one or more annotations selected from the group, comprising: (a) bars; (b) pictures; (c) icons; (d) indicators; (e) text; and (f) symbols.

Preferably, the method further comprises providing a toolbar for displaying the one or more categorized scores of the corresponding linked document.

Preferably, the method further comprises selecting the one or more parameters from the group, comprising: (a) anchor text; (b) category; (c) wording; (d) textual or graphical data (contents); (e) URL parameters; (f) creation or update data; (g) meta data; (h) author data; (i) owner data; (j) statistic data; and (k) history data.

Preferably, the method further comprises assigning one or more categorized scores to the linked document according to users' votes regarding one or more categories of said linked document.

Preferably, the method further comprises assigning one or more categorized scores to the linked document according to statistic data of the linking document.

Preferably, the method further comprises assigning one or more categorized scores to the linked document according to statistic data of said linked document.

Preferably, the method further comprises analyzing a home page or directory page of the at least one linking document for determining its relevancy to said at least one linking document, and assigning one or more categorized scores to the corresponding linked document accordingly.

Preferably, the method further comprises one or more of the following: (a) analyzing one or more parameters of the at least one lining document for determining one or more types of history data of said at least one linking document; and (b) analyzing one or more parameters of the linked document for determining one or more types of history data of said linked document.

Preferably, the method further comprises selecting the history data form the group, comprising: (a) content(s) update(s) or change(s); (b) creation date(s); (c) ranking history; (d) categorized ranking history; (e) traffic data history; (f) query(is) analysis history; (g) unique word(s) usage history; (h) URL data history; (i) user behavior history; (j) user maintained or generated data history; (k) phrase(s) in anchor text usage history; (l) linkage of an independent peer(s) history; (m) anchor text content(s) history; (n) document topic(s) history; (o) meta data history; and (p) bigram(s) history.

Preferably, the method further comprises analyzing the linked document or determining a probability of the linked document to be assigned with one or more categorized scores, said probability is determined according to the one or more of the following: (a) the linked document history; (b) the linked document statistic data; and (c) the linked documents users' votes regarding one or more categories of said linked document.

Preferably, the method further comprises enabling the user to narrow his search if the one or more documents, displayed to said user, relate to more than one category.

Preferably, the method further comprises narrowing the list of search results by selecting the corresponding category within all categories related to user's search query.

A method for enabling a user, searching a data network, to vote for a document stored within a database over said data network comprises: (a) providing a search results list to said user, according to his search query; (b) providing one or more categorized voting scales for one or more documents within said search result list, said voting scales enabling said user to select corresponding one or more categorized evaluations for each of said one or more documents; and (c) submitting by said user to a search engine provider said one or more categorized evaluations.

Preferably, the method further comprises receiving the one or more categorized evaluations of the document by means of the search engine provider and updating one or more categorized scores of said document.

A method for enabling a user to vote for a document stored within a database over a data network comprises: (a) embedding within said document corresponding program code that enables displaying one or more voting scales to each user opening said document, each of said voting scales comprising two or more evaluations of said document; and (b) voting, by means of each user, for said document by selecting corresponding evaluation from said two or more evaluations, and submitting said corresponding evaluation to a server.

Preferably, the method further comprises receiving the evaluation of the document by means of a search engine provider and updating a score of said document.

Preferably, the method further comprises providing at least one categorized voting scale within the one or more voting scales.

Preferably, the method further comprises receiving one or more categorized evaluations of the document by means of a search engine provider and updating corresponding one or more categorized scores of said document.

### BRIEF DESCRIPTION OF THE DRAWINGS

In the drawings:

FIG. 1 illustrates an example of the prior art method of documents ranking;

FIG. 2A illustrates a method for assigning a number of categorized scores to each document, according to a preferred embodiment of the present invention;

FIG. 2B illustrates a general case for calculating categorized rank of a linked page, according to a preferred embodiment of the present invention;

FIG. 2C illustrates a method for assigning a number of categorized scores to each document, according to another preferred embodiment of the present invention;

FIG. 2D illustrates a method for assigning a number of categorized scores to each document, according to still another preferred embodiment of the present invention;

FIG. 2E illustrates a method for assigning a number of categorized scores to each document, according to still another preferred embodiment of the present invention;

FIG. 3 illustrates a method for assigning a number of categorized scores to each document, according to a further preferred embodiment of the present invention;

FIG. 4 is an illustrative representation of a possible way for calculating an overall categorized rank for each linked document, according to a preferred embodiment of the present invention;

FIG. 5A to FIG. 5C illustrate a number of rank scales for documents, according to a preferred embodiment of the present invention;

FIG. 5D illustrates an average rank scale for a document, according to another preferred embodiment of the present invention;

FIG. 6 illustrates user's search queries 601 and 602 for the terms “tennis courts” and “test books”, respectively, according to a preferred embodiment of the present invention;

FIG. 7A to FIG. 7C are schematic illustrations of toolbar 701, comprising a number of categorized ranks of a page, according to preferred embodiments of the present invention;

FIG. 8A is a schematic illustration of enabling a user to vote for a document, according to a preferred embodiment of the present invention;

FIG. 8B is another schematic illustration of enabling a user to vote for a document by providing one or more categorized evaluations (votes) of said document, according to another preferred embodiment of the present invention;

FIG. 8C is still another schematic illustration of enabling a user to vote for a document by providing one or more categorized evaluations of said document, according to still another preferred embodiment of the present invention;

FIG. 9 is a schematic illustration of a table, comprising documents ordered according to their statistic data, such as average daily or monthly visits, etc., according to a preferred embodiment of the present invention; and

FIG. 10 is a schematic illustration of conducting a search over a data network, when using one or more search keywords that relate to more than one category, according to a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

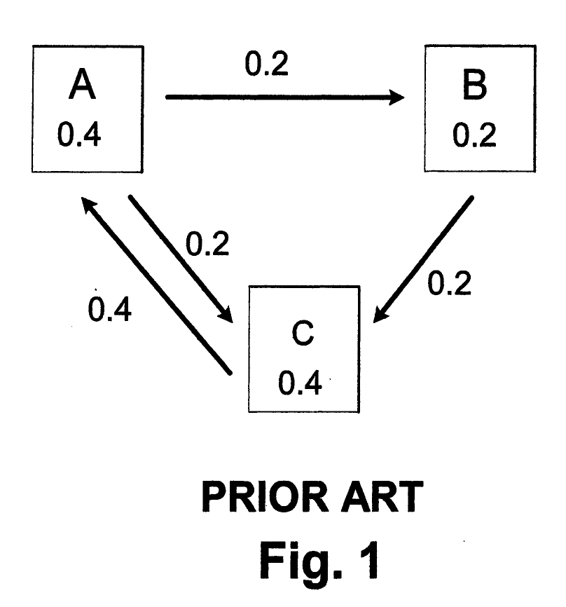

FIG. 1 illustrates an example of the prior art method of documents ranking. Document A has a single backlink to document C, and this is the only forward link of document C, so the rank of A is equal to the rank of C (r(A)=r(C)). Document B has a single backlink to document A, but this is one of two forward links of document A, so the rank of B is equal to half of the rank of A (r(B)=r(A)/2). Document C has two backlinks. One backlink is to document B, and this is the only forward link of document B. The other backlink is to document A via the other of the two forward links from A. Thus the rank of C is equal to the sum of the rank of B and half of the rank of A (r(C)=r(B)+r(A)/2). In this illustrative case it is seen that r(A)=0.4, r(B)=0.2, and r(C)=0.4.

However, according to the prior art each document has a single rank. When a user makes a search query at a search engine implemented by the above prior art scoring method, he receives a list of search results organized by the way that documents with a higher rank are placed at the top of said list. This prior art method has many drawbacks, allowing webmasters to optimize their Web sites by placing false links. One of the methods for placing false links is called “Link Exchange” or “Reciprocal Link Exchange”, which is the practice of exchanging links with other Web sites. The usual way of doing it, is to email another Web site webmaster and ask him to do a link exchange. One person places a link on his site, usually on a links page (document) and the other one, in return, places back a link from his site. In other words, Web site webmasters agree among them to place links to each other Web sites from their Web sites pages, and by this way they dramatically increase their Web sites pages ranks. Each webmaster creates at his Web site a number of pages, called “Links Pages” or “Link Partners” pages. These “Links Pages” can contain thousands of links to other Web sites on each page, wherein all these links can be absolutely not related one to the other. Sometimes, Web site webmasters categorize these pages by giving them categorized names, for example a “Computer” page, a “Marketing” page and etc. However, none of these pages actually contains any information related to its category name, besides links to other Web sites which may be related to said category name. As a result, if the “Computer” page, for example, has a high rank, then it is expected that all links from said “Computer” page would also obtain the high rank. Thus, a lot of documents over the Internet have false ranks leading to incorrect search results. Therefore, it is a continuous need to prevent assigning false ranks to documents over a data network. By assuring that all documents over the data network are assigned with the appropriate categorized score, a user searching the World Wide Web would obtain the best available search results for his search queries.

Hereinafter, when the term “document” is used it should be noted that it also relates to the terms “page”, “Web page” and the like, which are used interchangeably. The term “document” can be broadly interpreted as any machine-readable and machine-storable work product. A document may include an e-mail, a web site, a file, a combination of files, one or more files with embedded links to other files, a news group posting, a web advertisement, a blog, etc. In the context of the World Wide Web, a common document is a web page. Web pages often include textual information and may include embedded information (such as meta information, hyperlinks, images, pictures, graphics, logos, etc.) and/or embedded instructions (such as the JavaScript™, etc.). A page may correspond to a document or a portion of a document and vise versa. A page may also correspond to more than a single document and vise versa.

In addition, it should be noted, that the term “linking document” relates to a document having at least one link to another document; the term “linked document” relates to a document having at least one link from at least one another document. The linking document can be also the linked document (and vise versa) if it has at least one link to another document and at least one link from at least one another document.

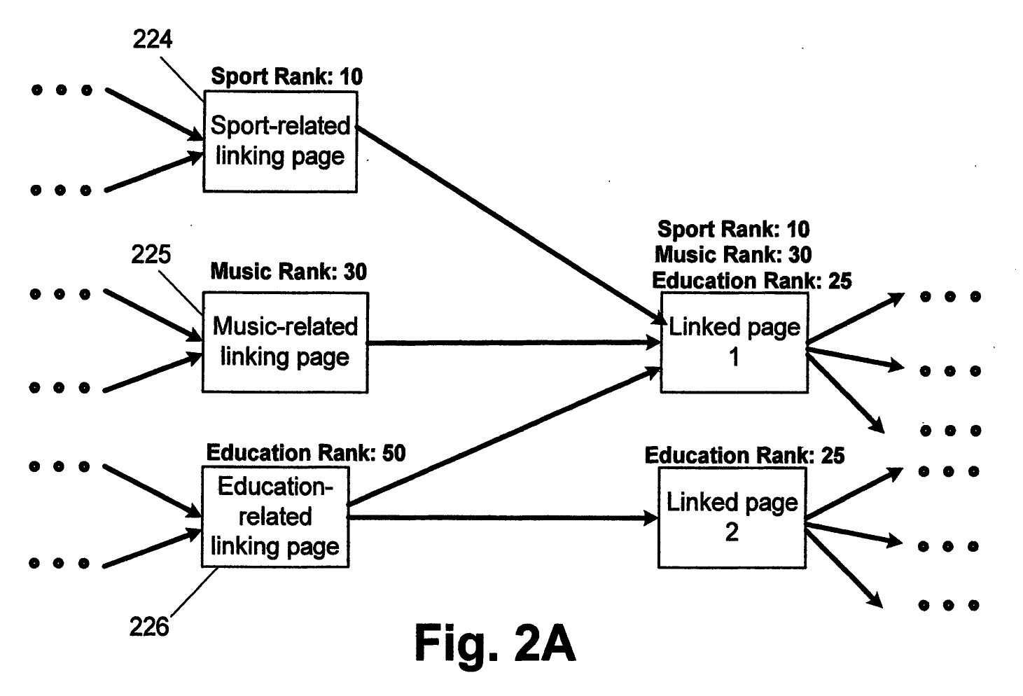

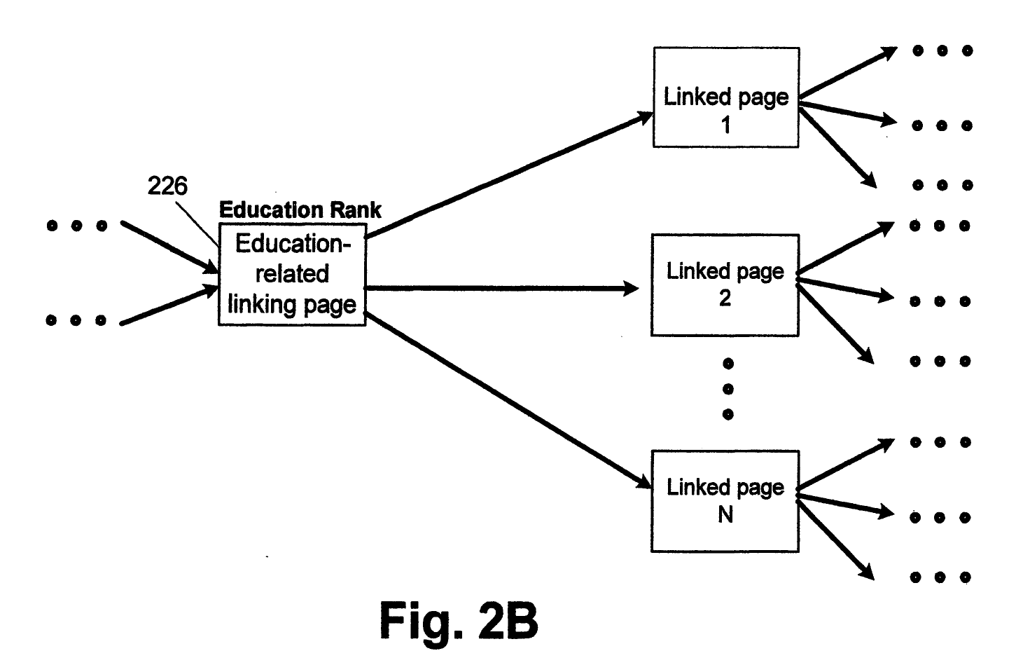

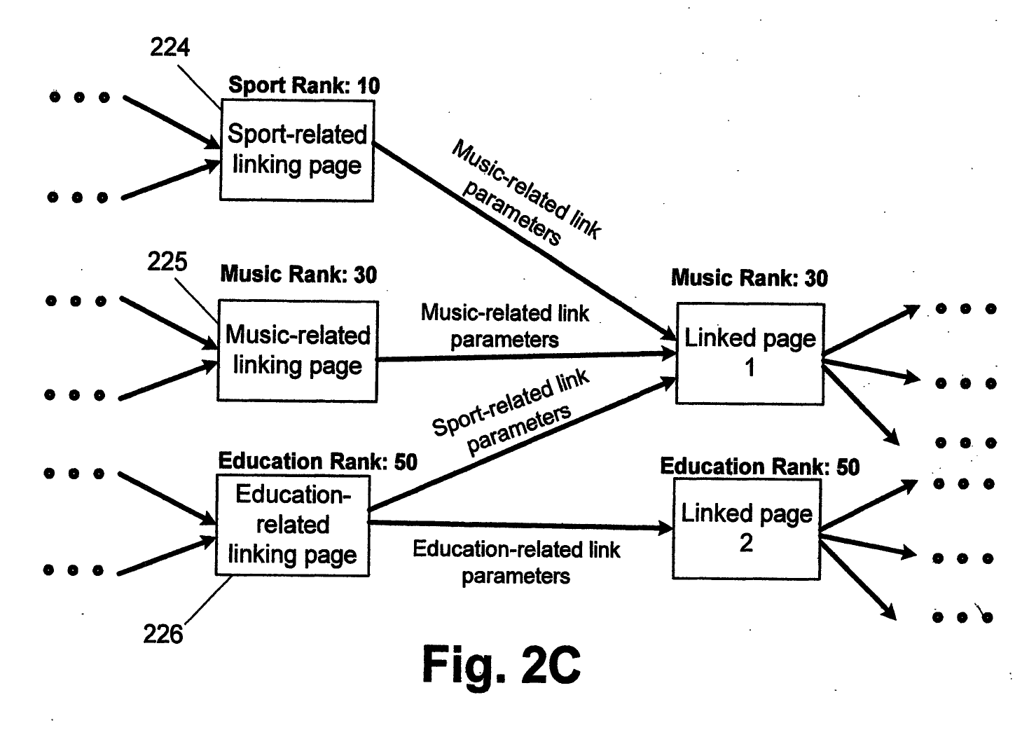

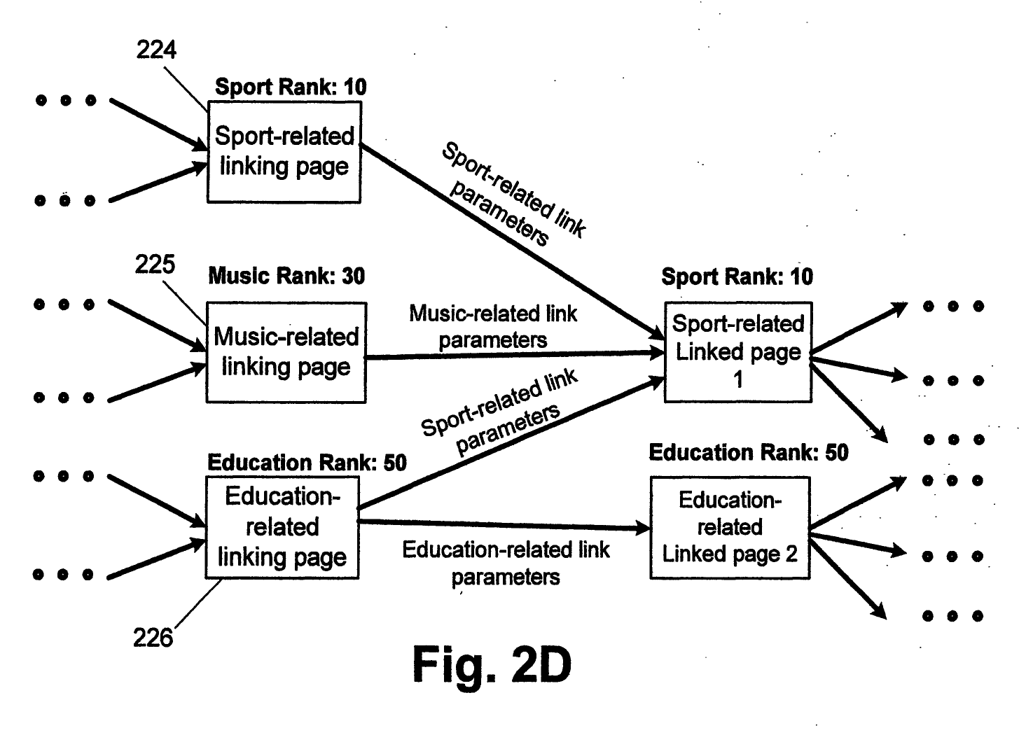

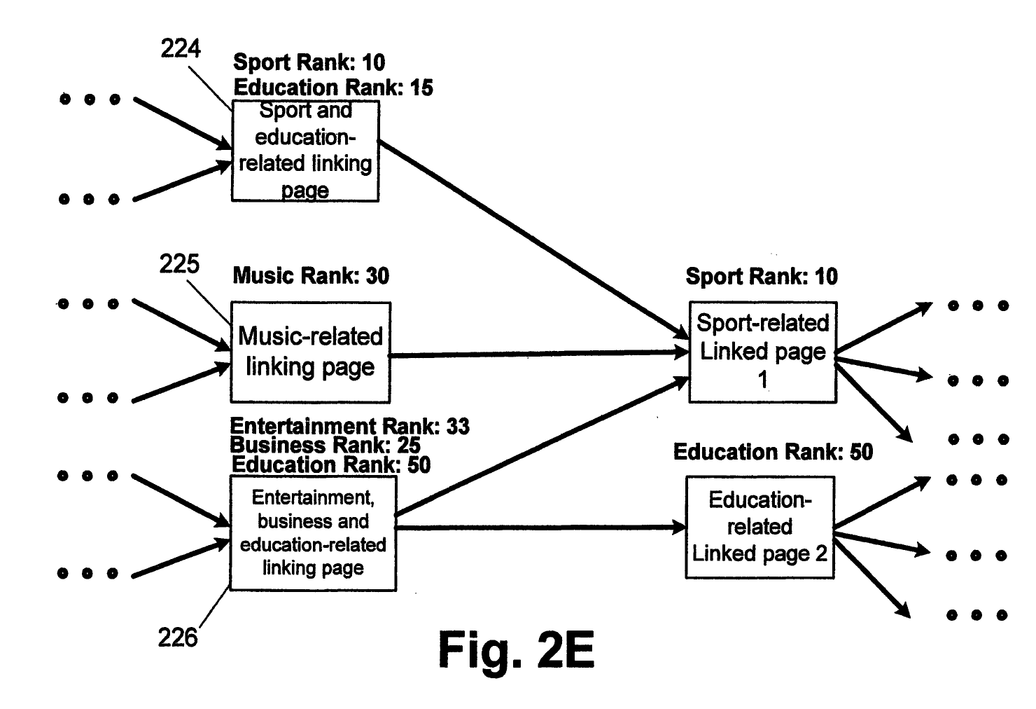

FIG. 2A illustrates a method for assigning a number of categorized scores to each document stored within a database over a data network, such as the Internet, according to a preferred embodiment of the present invention. For the simplicity, only three linking pages are shown: a sport-related linking page 224, a music-related linking page 225 and an education-related linking page 226. In addition, for the simplicity, are shown two linked pages: linked page 1 and linked page 2.

According to a preferred embodiment of the present invention, each page is assigned with at least one categorized rank, for example a sport rank, an entertainment rank, an electronics rank, a computer rank, a science rank and etc. A search engine provider decides to what details level he assigns categorized ranks to documents crawled by his search engine. The search engine provider can assign to said documents various general ranks, such as an education rank, a media rank, an entertainment rank, or said search engine provider can assign more detailed ranks, such as a leather clothes rank, a home business rank, an university rank, a car rent rank, etc. In addition, according to a preferred embodiment of the present invention each category rank is scored on a 100 score scale, wherein the lowest rank is 1 and the highest rank is 100. The categorized rank of zero (or an absence of the corresponding categorized rank) can indicate that a document is not related to the corresponding category. However, it should be noted that the present invention can be implemented in a variety of embodiments, and any score scale can be used, such as the 10 or 1000 score scale.

Sport-related linking page 224 has, for example, a sport rank of 10, and it links only to linked page 1. Music-related linking page 225 has a music rank of 30, and it also has a single link to linked page 1. Education-related linking page 226 has an education rank of 50, and it links to both linked page 1 and linked page 2. As a result, linked page 1 obtains: (a) a certain sport rank due to the rank of sport-related linking page 224; (b) a certain music rank due to the rank of music-related linking page 225; and (c) a certain education rank due to the rank of education-related linking page 226. The categorized rank of each linking page contributes to an increase in the linked page categorized rank only of the corresponding category. Therefore, the music rank of page 225 contributes only to an increase in the music rank of linked page 1 and do not contribute to an increase in the sport rank, for example, of said linked page 1. Of course, if a linking page rank category is, for example, sport and a linked page rank category is, for example, basketball (and vise versa), then said linking page rank would contribute to an increase in the linked page categorized rank, since the basketball is a subcategory of the sport category.

There can be a variety of ways to calculate a linked page rank due to the linking pages ranks (due to links from linking pages). For the simplicity, according to a preferred embodiment of the present invention, a categorized rank of each linking page is divided among linked pages. For example, if education-related linking page 226 has the education rank of 50 and it links to a couple of linked pages (linked page 1 and linked page 2), then the education rank of each said linked page is 50/2=25. Similarly, the sport rank of linked page 1 is 10, and the music rank of linked page 1 is 30. However, this method of dividing a categorized rank of each linking page among categorized ranks of linked pages is inaccurate. The categorized rank of linked page 1 does not have to suffer from the fact that linking page 226 has two outgoing links instead of 1 (one link to linked page 1 and another one to linked page 2). Therefore, according to another preferred embodiment of the present invention the categorized rank of linked page 1 can be calculated by the following formulation: R(linked_page_1)=K·R(linking_page), wherein R(linked_page_1) is a categorized rank of linked page 1, R(linking_page) is a categorized rank of education-related linking page 226 and K is a constant between 0 and 1 (0<K≦1). In other words, the categorized rank of each linking page can not be divided between all corresponding linked pages, and as a result the categorized rank of each linked page can be equal to the corresponding categorized rank of the corresponding linking page.

According to stir another preferred embodiment of the present invention, the categorized rank of page 226 can be divided among linked pages 1 and 2 by the following equations: R(linked_page_1)=K·R(linking_page) and R(linked_page_2)=(1−K)·R(linking_page), wherein R(linked_page_2) is a categorized rank of linked page 2; R(linking_page) is a categorized rank of education-related linking page 226. The value of K can be determined by the relevance of linked page 1 and 2 to the linking page 226. In addition, the value K can be determined by analyzing the relevance of each link to the corresponding linking and/or linked page. The relevance of said link and/or the relevance of said linking page and/or the relevance of said linked page can be determined by analyzing a plurality of parameters of said link and/or linking page and/or linked page, such as anchor text, category, wording, textual or graphical data (contents), URL parameters (such as URL wording, URL domain owner or registrar), creation or update data (such as creation or update date or time, age, etc.), author data, meta data, owner data, statistic data (such as users' number of clicks), history data (such as users' past searches related to said link and/or linking page and/or linked page) and any other parameters (properties) which can assist for determining link relevance. For example, the relevance of the linked page, such as linked page 1, to linking page 226 can be determined by analyzing contents of said linked page 1 and linking page 226 and finding words matches. In addition can be analyzed titles, headers, meta-data of linking and/or linked pages for determining synonyms, antonyms and the like. Further can be analyzed pictures, multimedia contents or any graphical contents of both linked page 1 and linking page 226 for determining similarity between these pages.

The more general case for calculating categorized rank of linked pages is illustrated on FIG. 2B. Education-related linking page 226 has certain education rank R(linking_page). This page 226 has N links to other pages (linked pages). The education ranks if each linked page are calculated as follows:

R(linked_page_1)=K₁·R(linking_page);

R(linked_page_2)=K₂·R(linking_page); . . . and

R(linked_page_{—}N)=K_{N}·R(linking_page),

wherein K₁, K₂, . . . , K_{N} (K₁+K₂+ . . . +K_{N}=1) are constants determined by the relevance of linked pages 1, 2, . . . , N, respectively, to linking page 226. In addition, the values of K₁, K₂, . . . , K_{N} can be determined by the relevance of one or more parameters of each corresponding link to corresponding linked page 1 or 2, and/or by the relevance of one or more parameters of each corresponding link to linking page 226.

FIG. 2C illustrates a method for assigning a number of categorized scores to each document stored within a database over a data network, such as the Internet, according to another preferred embodiment of the present invention. In this preferred embodiment, one or more link parameters (properties), such as the anchor text, category, wording, textual or graphical data (contents), URL parameters (such as URL wording, URL domain owner or registrar), creation or update data (such as creation or update date or time, age, etc.), author data, owner data, meta data, statistic data (such as users' number of clicks), history data (such as users' past searches related to said link a) and any other parameters which can assist for determining link relevance are considered for determining the weight of said link. In other words, links are analyzed and, optionally, categorized according to their parameters. If a linking page rank category (or linking page one or more parameters) and a link category (or link one or more parameters) do not match (or it is hard to determine whether the linking page and the link from said linking page are related, or it is hard to categorize said linking page and/or said link), then such link do not contribute to an increase of the corresponding linked page categorized rank. Of course, if linking page rank category is, for example, sport and link category is, or example, basketball (and vise versa), then it is considered as a match, since the basketball is a subcategory of the sport category.

Sport-related linking page 224 links to linked page 1 by a link having music-related parameters. In addition, music-related linking page 225 links to linked page 1 also by a link having music-related parameters. Further, education-related linking page 226 links to linked page 1 by a link having sport-related parameters and to linked page 2 by a link having education-related parameters. As a result, linked page 1 obtains only the music rank of 30; and linked page 2 obtains only the education rank of 50.

According to another preferred embodiment of the present invention, if a linking page rank category and a link category (link one or more parameters) do not match (or it is hard to determine whether the linking page and the link from said linking page are related, or it is hard to categorize said linking page and/or said link), then such link can still contribute to an increase of the categorized rank of the corresponding linked page. The relevance of said link one or more parameters to said lining page parameters (or category) can be scaled and scored. If for example, the linking page is sport-related and its content contains the word “ball”, and the link one or more parameters also contain (or are related to) the word “ball”, then the relevance between said linking page and said link can be scored as 1, for example, on a 100 grade scale. As a result, if the above link (whose one or more parameters contain or are related to the word “ball”) is the only link to a linked page, the corresponding categorized rank of said linked page can be calculated as follows: R(linked_page)=K·R(linking_page), wherein K can be, for example, equal to 0.01 or 0.001 (it would have some relatively small value).

It should be noted that according to a preferred embodiment of the present invention, if a search keyword(s) relate to more than one category, then the user can be provided with a list of related categories for selecting a category that is the most appropriate for his search. For example, if the search keyword “test” relates to “education”, “medicine” and “sport” categories, then the user selects the most appropriate category for his search.

FIG. 2D illustrates a method for assigning a number of categorized scores to each page stored within a database over a data network, such as the Internet, according to still another preferred embodiment of the present invention. According to this preferred embodiment, the linked page one or more parameters, such as the anchor text, category, wording, URL wording (or any other URL data), etc. are considered for determining the weight of the link to said linked page. If a linking page one or more parameters (or linking page rank category), link one or more parameters (or link category) and linked page one or more parameters (or linked page rank category) do not match (or it is hard to determine whether the linking page, the link from said linking page and the linked page are related, or it is hard to categorize said linking page and/or said link and/or said linked page), then such link do not contribute to an increase of the categorized rank of the corresponding linked page. Of course, if linking page category is, for example sport, link category is, for example, basketball and linked page category is, for example, tennis (and vise versa), then it is considered as a match, since the basketball and tennis are subcategories of the sport category.

Sport-related linking page 224 links to sport-related linked page 1 by a link having sport-related parameters. In addition, music-related linking page 225 links to sport-related linked page 1 by a link having music-related parameters. Further, education-related linking page 226 links to sport related linked page 1 by a link having sport-related parameters and to education-related linked page 2 by a link having education-related parameters. As a result, sport-related linked page 1 obtains only sport rank of 10 and education-related linked page 2 obtains only education rank of 50. According to another preferred embodiment of the present invention, if one or more parameters of a linking page (or a category of a linking page), one or more parameters of a link (or a category of a link) and one or more parameters of a linked page (or a category of a linked page rank) do not match (or it is hard to determine whether these categories are related, or it is hard to categorize said linking page, and/or said linked page, and/or said link), then such link can still contribute to the increase of the corresponding linked page rank. The relevance of said link category to said linking page category and to said linked page category can be scaled and scored. If for example, the linking and linked pages are both sport-related and their one or more parameters contain the word “ball” (or are related to the word “ball”), and the link one or more parameters also contains the word “ball” (or are related to the word “ball”), then the relevance of the link to the linked and linking pages can be scored as 1, for example, on a 100 grade scale. As a result, if the above link (whose one or more parameters are related or contain the word “ball”) is the only link to a linked page, the corresponding categorized rank of said linked page can be calculated as follows: R(linked_page)=K·R(linking_page), wherein K can be, for example, equal to 0.01 or 0.001 (it would have some relatively small value).

FIG. 2E illustrates a method for assigning a number of categorized scores to each page stored within a database over a data network, such as the Internet, according to still another preferred embodiment of the present invention. According to this preferred embodiment, one or more parameters of each link from at least one linking page to the corresponding linked page are not considered for assigning one or more categorized scores to said linked page.

Sport and education-related linking page 224 has the sport rank of 10 and the education rank of 15. It links to sport-related linked page 1. In addition, music-related linking page 225 has the music rank of 30 and it also links to sport-related linked page 1. Further, entertainment, business and education-related linking page 226 has the entertainment rank of 33, business rank of 25 and education rank of 50. Its links to sport-related linked page 1 and to education-related linked page 2. The search engine provider determines the categorized scores of said linking pages and analyzes one or more parameters of said linked pages 1 and 2 for determining the relevance of said each linked pages 1 and 2 to the corresponding linking document(s). The parameters are selected from a group, comprising for example: wording, textual or graphical data (contents), URL parameters (such as URL wording, URL domain owner or registrar), creation or update data (such as creation or update date or time, age, etc.), category, anchor text, author data, meta data, owner data, statistic data (such as users' number of clicks), history data (such as users' past searches related to said link and/or linking page and/or linked page) and any other parameters (properties) which can assist for determining the relevance of the linked document to the corresponding linking document. Since it is supposed in FIG. 2E that linked page 1 is sport-related, then said linked page 1 is assigned only with the sport rank (for example, the sport rank of 10) due to the link from sport and education-related linking page 224. Linking pages 225 and 226 are not sport-related, and therefore their do not contribute to an increase in the sport rank of the sport-related linked page 1. In addition, since that it is supposed in FIG. 2E that linked page 2 is education-related, then said linked page 2 is assigned only with the education rank (for example, the education rank of 50) due to the link from entertainment, business and education-related linking page 226.

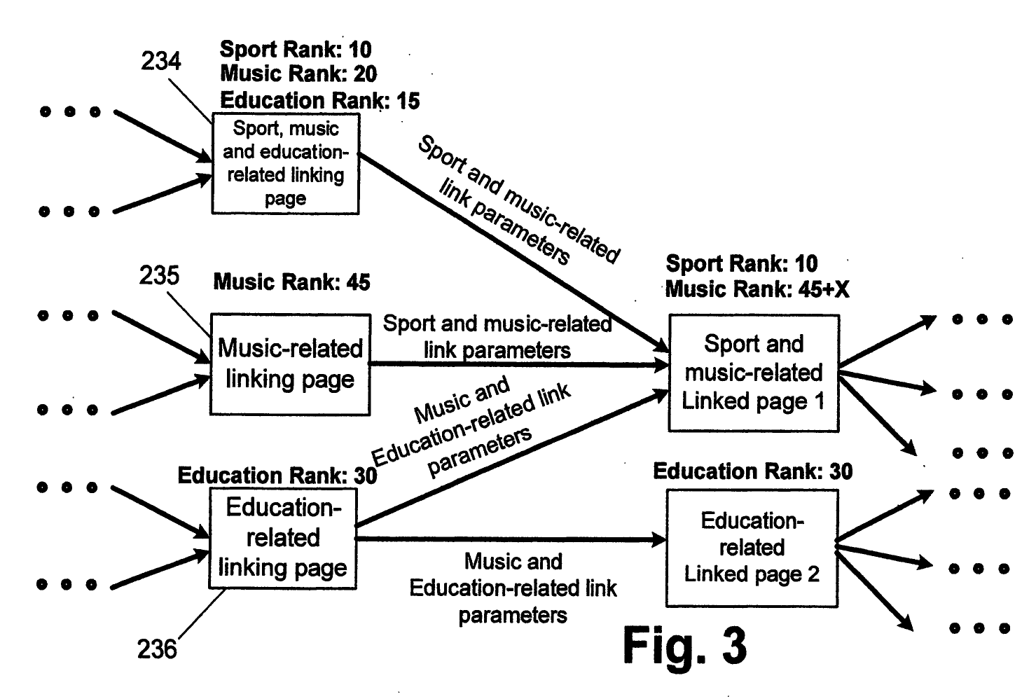

FIG. 3 illustrates a method for assigning a number of categorized scores to each page stored within a database over a data network, such as the Internet, according to a further preferred embodiment of the present invention. This preferred embodiment is more related to a Web site home pages and Web site directory pages, such as www.yahoo.com™ or http://movies.yahoo.com™, which can be categorized to a number of categories or subcategories.

Sport, music and education-related linking page 234 has the sport rank of 10, music rank of 20 and education rank of 15. Page 234 links to sport and music-related linked page 1 by a link having sport and music related parameters. In addition, music-related linking page 235 has the music rank of 45. Page 235 links to sport and music-related linked page 1 by a link having sport and music-related link parameters. Further, education-related linking page 236 has only the education rank of 30. Page 236 links to education-related linked page 2 by a link having education and music-related parameters.

If a linking page one or more parameters (or linking page rank category), link one or more parameters (or link category) and linked page one or more parameters (or linked page rank category) do not match (or it is hard to determine whether the linking page, the link from said linking page and the linked page are related, or it is hard to categorize said linking page and/or said link and/or said linked page), then such link do not contribute to an increase of the categorized rank of the corresponding linked page. As a result, sport and music-related linked page 1 obtains sport rank of 10 and a certain music rank (45+X) due to the links from pages 234 and 235. The sport rank of said sport and music-related linked page 1 is equal to the sport rank of page 234, since the sport-related link (which is also music-related) from music-related page 235 do not match the music category to which page 285 is related, and therefore it does not increase the sport rank of said linked page 1. Also, linked page 1 does not have any education rank, since it does not relate to the education category, and it does not relate to education-related linking page 236 (and to the education category or to one or more education parameters of linking page 234) and to the corresponding education-related link (which is also music-related) from said page 236. In addition, the music and education-related link from page 236 do not increase the music rank of said linked page 1, since linking page 236 does not relate to the music category. The education-related linked page 2 has the education rank of 30 due to the education-related link (which is also music related) from education-related page 236.

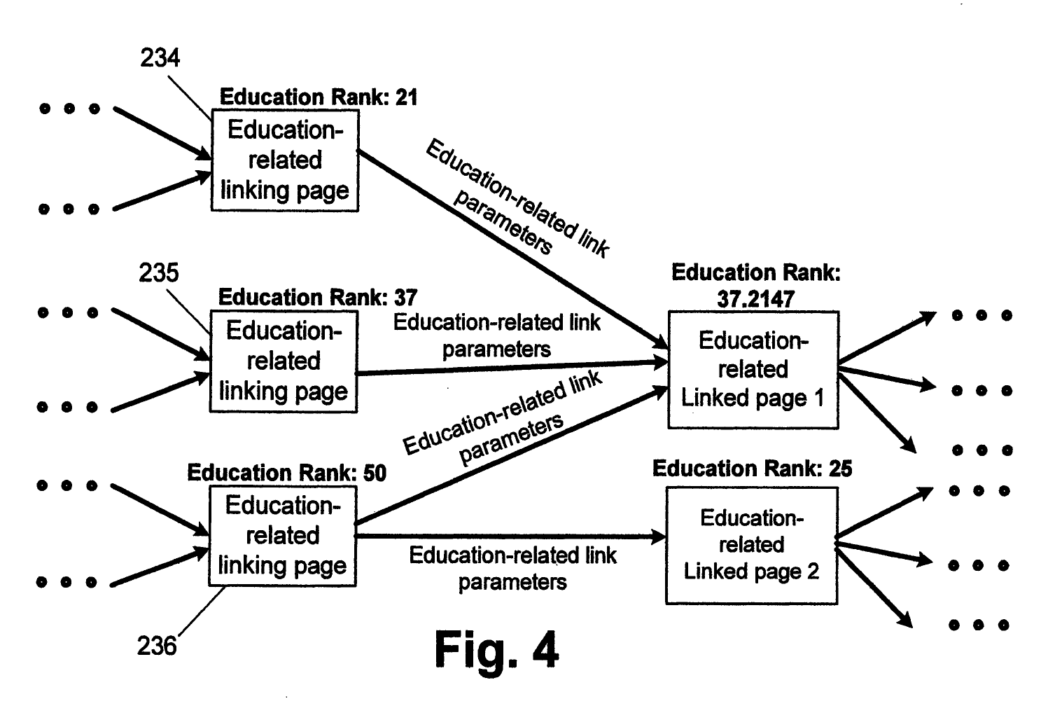

It should be noted, that there are a number of ways to calculate the music rank (45+X) of the linked page 1 due to the music-related links from music-related linking pages 234 and 235. One possible way for calculating said rank is illustratively represented in FIG. 4.

FIG. 4 is an illustrative representation of a possible way for calculating an overall categorized rank for each linked document within a database over a data network, such as the Internet, according to a preferred embodiment of the present invention. The first education-related linking page 234 has the education rank of 21; the second education-related linking page 235 has the education rank of 37; and the third education-related linking page 236 has the education rank of 50. Page 234 links to educated-related linked page 1 by an education-related link. Page 235 also links to educated-related linked page 1 by an education-related link. In addition, page 236 links to both education-related linked pages 1 and 2 by education-related links. For the simplicity, it is supposed that education-related linked page 2 obtains the rank of 25 by equally dividing education rank of page 236 among linked page 1 and linked page 2. The overall education rank of linked page 1 can be calculated in various ways. One possible ways is by using the following formulation: Const.^{R}^{_{—}}¹+Const.^{R}^{_{—}}²+Const.^{R}^{_{—}}³+ . . . +Const.^{R}^{_{—}}^{N}=Const.^{R}^{_{—}}^{overall}, wherein Const. is a constant, predetermined by search engine provider; R_1, R_2, R_3 . . . R_N are categorized ranks of the corresponding linking pages; and R_overall is the overall categorized rank of linked page 1. The value of Const. can be, for example, 1.3. However, any other value, such as 1.2 or 3 can be applicable. By using the above formulation and substituting the Const. with 1.3, the education rank of education-related linked page 1 is approximately 37: 1.3²¹+1.3³⁷+1.3²⁵=1.3^{37.2147}=≈1.3³⁷. The rank is calculated by solving a simple logarithmic equation:

$$R\_overall = \frac{log ( {1.3}^{21} + {1.3}^{37} + {1.3}^{25} )}{log ( 1.3 )} = 37.2147 .$$

It should be noted, that each linked page having at least one link form at least one linking page can have at least the rank of 1 on the 100 scale. The maximal rank for each page stored within a database over a data network can be 100 on the 100 scale, or 1000 on 1000 scale and the like.

It should be noted, that according to a preferred embodiment of the present invention, in the initial state (before assigning one or more categorized scores to each linked page) all documents stored within a database over a data network can have a predetermined constant or variable categorized rank. For example, all or a part of all documents can be initially assigned with the categorized rank of 0 (or any other small categorized rank) in all or in a part of all categories, said categories predetermined by a search engine provider. According to another preferred embodiment of the present invention, all or a part of all documents can be categorized and initially assigned with the categorized rank of 0 (or any other small categorized rank) only in the corresponding one or more categories to which these documents are related (in other available categories, predetermined by the search engine provider, these documents can not have any categorized rank at all).

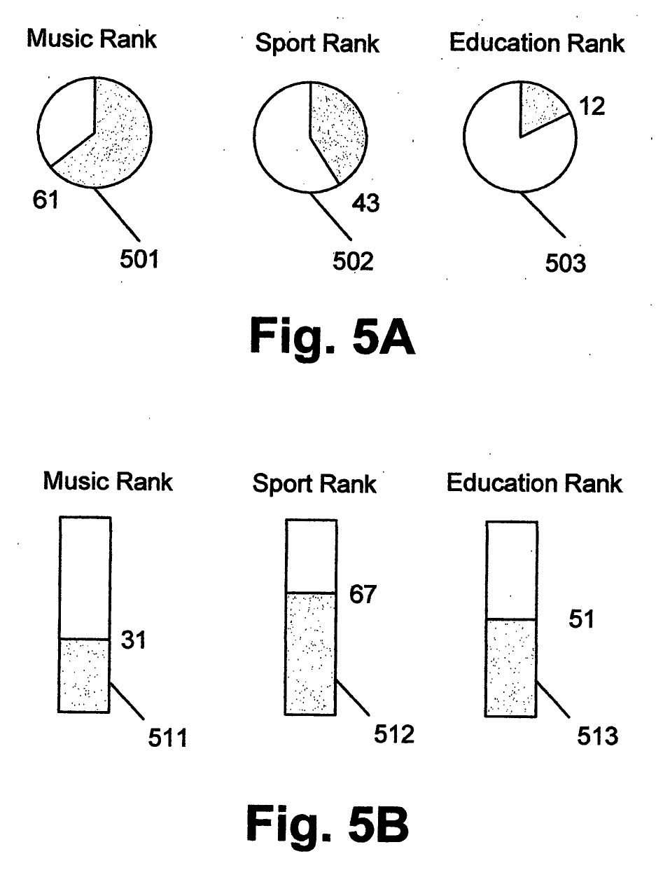

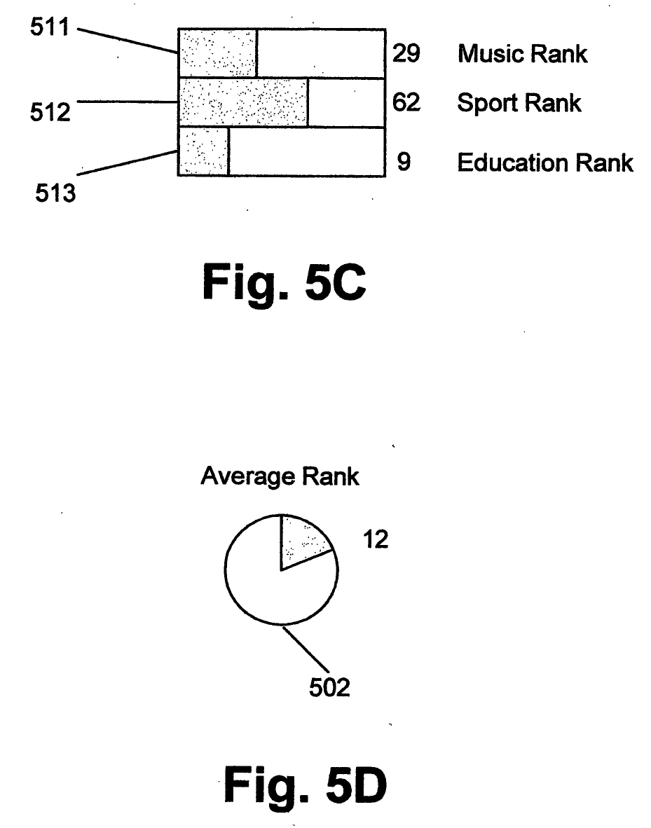

FIG. 5A to FIG. 5C illustrate a number of rank scales for documents within a database over a data network, such as the Internet, according to a preferred embodiment of the present invention. On FIG. 5A are illustrated circular categorized rank scales 501, 502 and 503 of a document or of a number of documents. The dashed sections represent a current categorized rank for each category. For the music category the rank is 61, for the sport category—43 and for the education category—12. Similarly, on FIGS. 5B and 5C are illustrated rectangular categorized rank scales 511, 512, 513, according to other preferred embodiments of the present invention. It should be noted, that the rank scales can have a variety of forms and embodiments, and the above rank scales are illustrated for the example only.

It should be noted, that according to a preferred embodiment of the present invention, only categorized ranks to which each corresponding linked page is related can be displayed. If the linked page relates only to a sport category, then only its sport rank is displayed. Other ranks (which can be zero) are not displayed at all or they can be displayed upon user's request.

FIG. 5D illustrates an average rank scale for a document within a database over a data network, such as the Internet, according to another preferred embodiment of the present invention. The search engine provider can assign to each document an average rank, based on categorized ranks of said page using a predetermined formulation. For example, suppose that search engine provider assigns to each page the following 5 categorized ranks: an entertainment rank (E.R.), a sport rank (S.R.), an education rank (Ed.R.), a leisure rank (L.R.) and a business rank (B.R.). Then said search engine provider can calculate the average rank (A.R.) by using the following formulation: A.R.=E.R.·0.2+S.R.·0.2+Ed.R.·0.2+L.R.·0.2+B.R.·0.2. Each component within the above formulation is equally multiplied by 0.2, since 1/5=0.2 (or 100%/5=20%). Of course, different multipliers (instead of 0.2) can be applied to each category, according to the search engine provider wish. For example, the search engine provider can decide to give for the education category more weight by multiplying it by 0.3 instead of 0.2. However, the sum of all multipliers has to remain to be equal to 1.

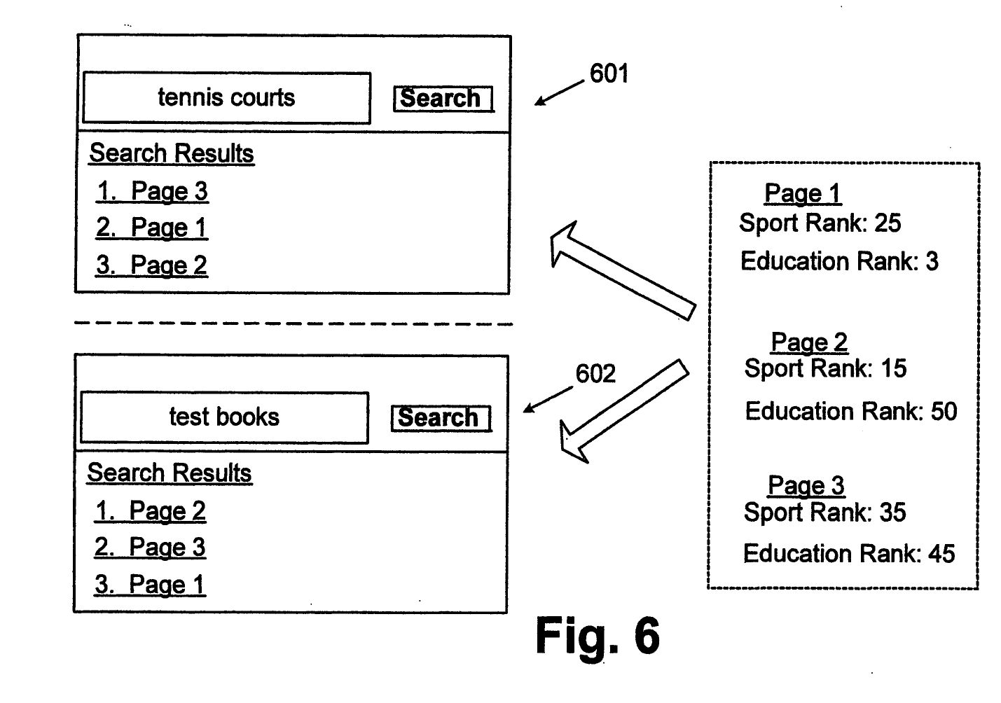

FIG. 6 illustrates user's search queries 601 and 602 for the terms “tennis courts” and “test books”, respectively, according to a preferred embodiment of the present invention. After at least one categorized scores is assigned to one or more documents over the data network, then these document are processed according to their categorized scores. It is supposed for the example, that there are only three pages within a searchable database: page 1 having the sport rank of 25 and the education rank of 3; page 2 having the sport rank of 15 and the education rank of 50; and page 3 having the sport rank of 35 and the education rank of 45. At the first processing stage each search term can be categorized for determining to what category it is related. Then each page within the searchable database is checked for a number of predetermined parameters: whether said each page has some categorized rank relating to the search term (or to the search term category); whether the search term is included within the contents, title, header and other data of said each page. At the final processing stage, the relevant pages are displayed to the user in a predetermined order, according to their relevance determined by said predetermined parameters.

In FIG. 6, for the simplicity, is supposed that for determining an order of the displayed search results is considered only the categorized rank of each page 1, 2 and 3. Then for the search query “tennis courts”, the page 3 is the first, page 1 is the second and page 2 is the third (35>25>15). For the search query “test books”, the page 2 is the first, page 3 is the second and page 1 is the third.

According to a preferred embodiment of the present invention, a method for providing to a user, searching a database over a data network, one or more search results based on his query, comprises: (a) analyzing and/or categorizing a user's search query; (b) processing each document within a database for determining one or more documents being relevant to said user's search query by analyzing one or more parameters of said each document; (c) determining one or more categorized scores of said one or more documents and processing said one or more documents according to their relevance to the user's query and to their said one or more categorized scores; and (d) displaying to the user said one or more documents, being the search results, in a predetermined order, according to: (d.1.) their relevance to said user's search query, said relevance determined by analyzing said one or more parameters of said each document; and (d.2.) their one or more categorized scores.

According to a preferred embodiment of the present invention, the method for providing to a user, searching a database over a data network, one or more search results based on his query, further comprises displaying one or more annotations of the one or more categorized scores of the displayed one or more search results. The annotations can be, for example, selected from the group, comprising: (a) bars; (b) pictures; (c) icons; (d) indicators; (e) text; and (f) symbols and the like.

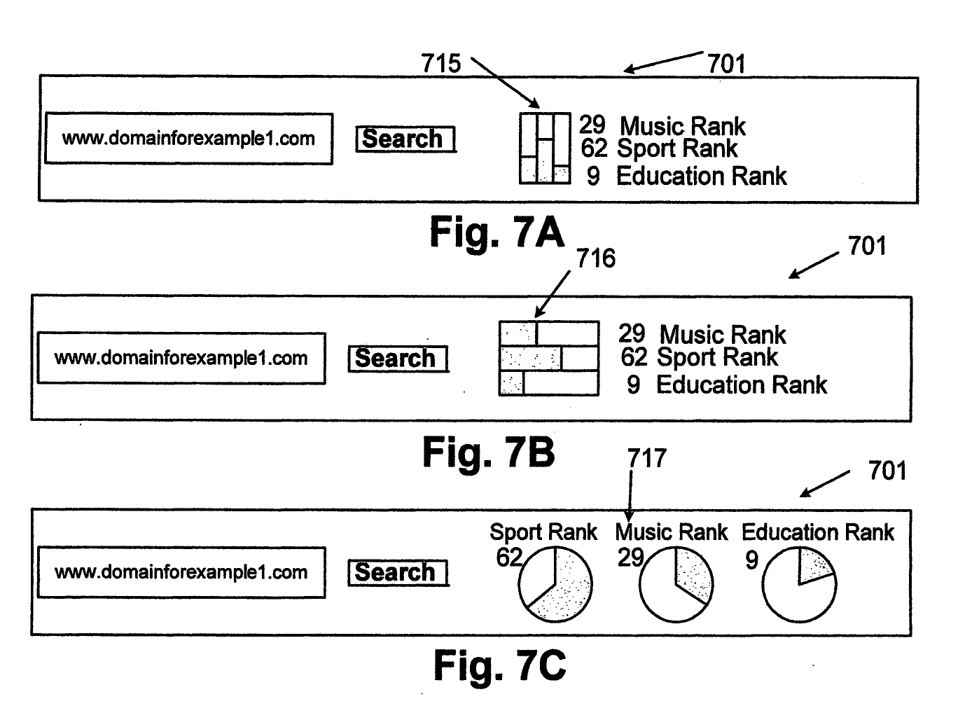

FIG. 7A to FIG. 7C are schematic illustrations of toolbar 701, comprising a number of categorized ranks of a page stored within a database over a data network, such as the Internet, according to preferred embodiments of the present invention. Toolbar is a line, which is usually located on the upper part of an application window and contains buttons, which operate application's tools. By means of said toolbars the user is provided with one or more categorized ranks of each document within said database. In addition, by pointing with a computer mouse on each corresponding categorized rank sections 715, 716 and 717, the user can be additionally provided in an appearing text box or in a new window with the categorized ranks complete data. The complete data can comprise each categorized rank update date and time, a list of corresponding linking documents, etc.

Also it should be noted, that according to a preferred embodiment of the present invention a data network can be any network, such as the Internet, Ethernet, LAN (Local Area Network), Cellular Internet, etc. In addition, a database can be any database of documents stored on a server or the like.

According to a preferred embodiment of the present invention, is provided a computer readable recording medium for storing a set of executable instructions for assigning one or more categorized scores to each linked document within a plurality of documents over a data network, said each linked document being linked from at least one linking document, comprising: (a) one or more instructions for obtaining a plurality of documents, wherein some documents are linked documents, some documents are linking documents, some linked documents are also being linking documents, and some linking documents are also being linked documents; and (b) one or more instructions for assigning one or more categorized scores to each linked document within said plurality of documents basing on one or more categorized scores of at least one corresponding linking document, and basing on one or more parameters of a link from said at least one corresponding linking document and/or basing on one or more parameters of said at least one corresponding linking document and/or basing on one or more parameters of said each linked document.

In addition, according to another preferred embodiment of the present invention is provided a computer readable recording medium for storing a set of executable instructions for determining assigned one or more categorized scores to each linked document within a plurality of documents over a data network, said each linked document being linked from at least one linking document, comprising: (a) one or more instructions for obtaining a plurality of documents, wherein some documents are linked documents, some documents are linking documents, some linked documents are also being linking documents, and some linking documents are also being linked documents; and (b) one or more instructions for determining one or more categorized scores assigned to each linked document within said plurality of documents, basing on one or more categorized scores of at least one corresponding linking document, and basing on one or more parameters of a link from said at least one corresponding linking document and/or basing on one or more parameters of said at least one corresponding linking document and/or basing on one or more parameters of said each linked document.

A computer readable recording medium, according to a preferred embodiment of the present invention, further comprises one or more instructions for processing each linked document within said plurality of documents basing on its one or more categorized scores.

It should be noted, that the instructions can be executed by at least one conventional processing unit, such as the CPU (Central Processing Unit), DSP (Digital Signal Processor), microcontroller, microprocessor and etc.

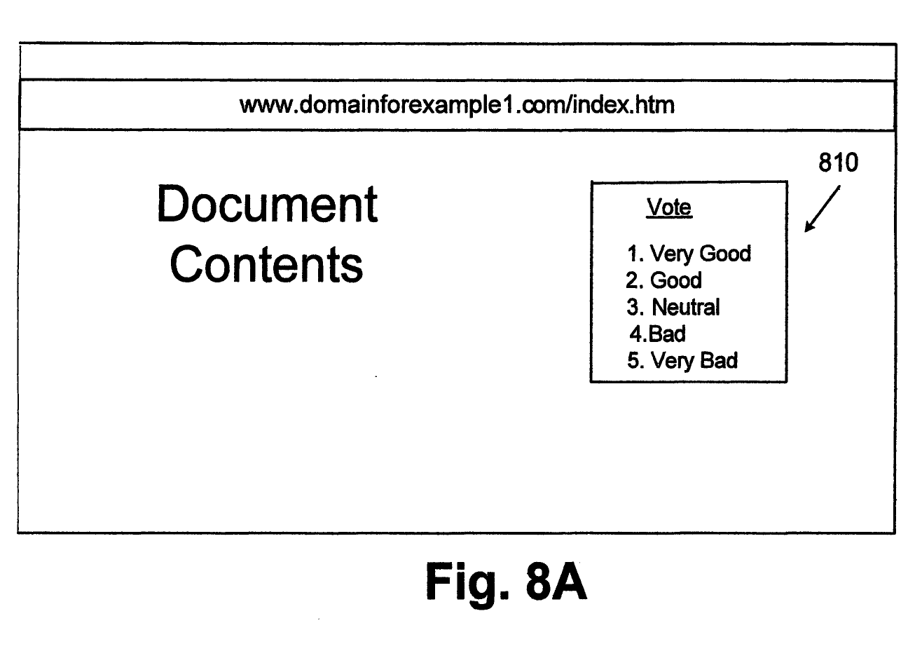

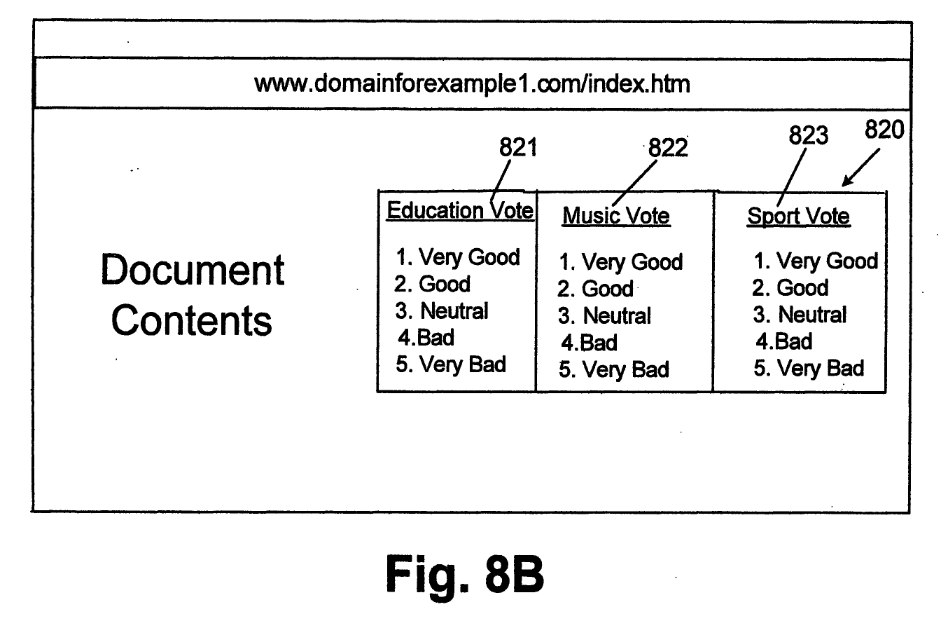

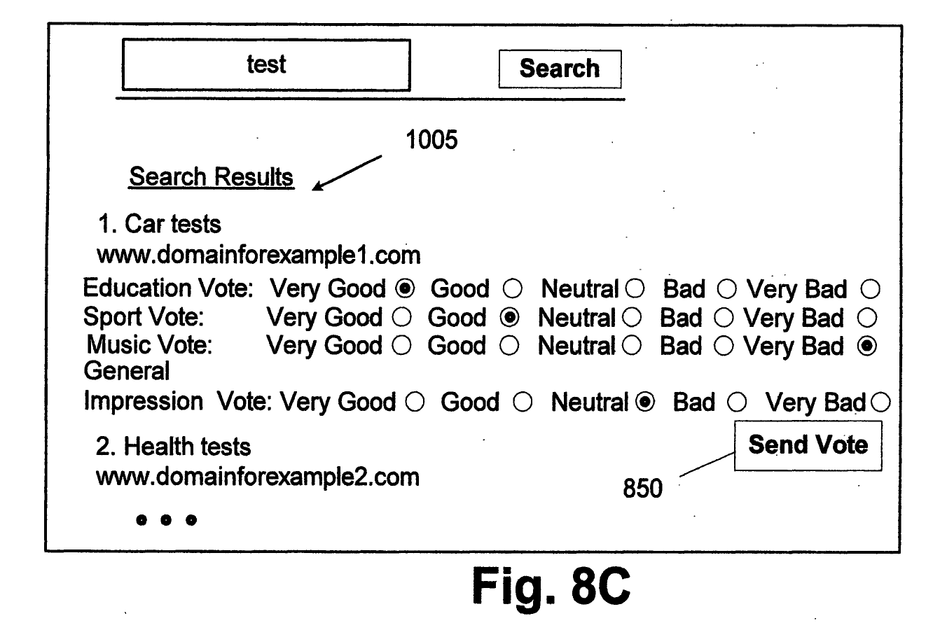

FIG. 8A is a schematic illustration of enabling a user to vote for a document stored within a database over a data network, such as the Internet, according to a preferred embodiment of the present invention. A Webmaster of each Web site places (embeds) on one or more Web pages of his Web site a corresponding program code (script), said program code is written, for example, by a programming language, such as JavaScript™ and provided by a search engine provider to said each Webmaster. The program code enables presenting a voting window 810 on said one or more Web pages to each user surfing to said pages. The user votes for each Web page, according to his impression from visiting said each Web page. The user selects an appropriate expression in voting window 810. If he is very impressed by visiting said Web page, he can select the score (evaluation) “1”—“Very Good”. Otherwise, he can select “2”—“Good”, “3”—“Neutral”, “4”—“Bad”, or “5”—“Very Bad”, for example. After the user votes for the Web page, his voting data is transferred to the search engine provider (to its server) and analyzed by said provider. Then, the search engine provider calculates and updates the corresponding categorized score(s) of said Web page, according to the overall voting results, obtained from a plurality of users visited said Web page. Each user's negative vote, such as the “Bad” or “Very Bad” vote can decrease one or more categorized ranks of said Web page, and each user's positive vote, such as the “Very Good” or “Good” can increase one or more categorized ranks of said Web page. According to this preferred embodiment of the present invention, users' votes relate to all categorized ranks of said Web page. For example, if the Web page www.domainforexample1.com/index.htm is education, music and sport-related, then the search engine provider calculates and updates all categorized ranks of said Web page (education, music and sport ranks) basing on users' votes. The weight of each user's vote can be equal for each Web page category. However, the search engine provider can consider a different weight for each user's vote for each Web page category, basing for example, on previous each categorized rank of said Web page. For example, if a Web page is mostly education-related, but it has also some sport rank (it is somehow sport-related), then the search engine provider can consider users' votes mostly for the education rank and process education and sport ranks of said Web page accordingly.

FIG. 8B is another schematic illustration of enabling a user to vote for a document by providing one or more categorized evaluations (votes) of said document, stored within a database over a data network, such as the Internet, according to another preferred embodiment of the present invention. The user, while surfing the World Wide Web, can vote for each Web page by providing one or more categorized votes, according to his impression from visiting said each Web page. For the example, in FIG. 8B is supposed that Web page www.domainforexample1.com/index.htm is education, music and sport-related. The user selects an appropriate expression in each category voting windows 821, and/or 822 and/or 823 within overall voting window 820. If he is very impressed by visiting said Web page, he can select in said one or more category voting windows 821, 822 and 823 the score (evaluation) “1”—“Very Good”. Otherwise, he can select the score “2”—“Good”, “3”—“Neutral”, “4”—“Bad”, or “5”—“Very Bad”. After the user votes for the Web page, his voting data is transferred to the search engine provider and analyzed by said provider. Then, the search engine provider calculates and updates the corresponding categorized scores of the Web page, according to voting results, obtained from a plurality of users visited said page.

It should be noted that each user (Web surfer) visiting a Web site that has voting windows 810 (FIG. 8A) or 820, can be provided with a plurality of possible voting scores, such as 10 or 100 different voting scores (on a 10 or 100 level score scale). The more possible voting scores are provided within each Web page, the more accurate this Web page can be rated by means of a search engine provider.

FIG. 8C is still another schematic illustration of enabling a user to vote for a document by providing one or more categorized votes to said document, stored within a database over a data network, such as the Internet, according to still another preferred embodiment of the present invention. When providing a list of search result 1005 to a user searching the Web, said user is also provided with a categorized voting scale enabling him to vote for the Web site/page. It is supposed, for example, that www.domainforexample1.com has Education rank of 22, Sport rank of 56 and Music rank of 9. The user can vote for each of the corresponding categories by selecting an appropriate vote and pressing the “Send Vote” button 850. If the user is very impressed by the Web site/page, he can vote “Very Good”, otherwise he can vote “Good”, “Neutral”, “Bad” and “Very Bad”. In addition, the user can provide a general vote for his overall impression of visiting said Web site/page. After the user votes for the Web site/page, his voting (evaluation) data is transferred to the search engine provider and analyzed by said provider. Then, the search engine provider calculates and updates the corresponding categorized scores of said Web site/page, according to voting results, obtained from a plurality of users visited said page.

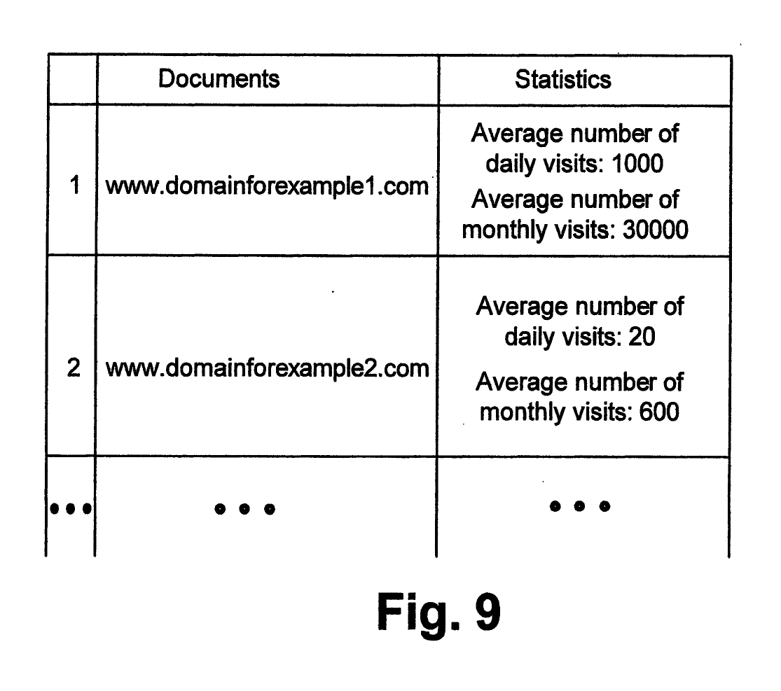

FIG. 9 is a schematic illustration of a table, comprising documents ordered according to their statistic data, such as average daily or monthly visits, etc., according to a preferred embodiment of the present invention. The search engine provider considers documents statistic data, such as documents traffic data, average daily or monthly downloads, etc. for assigning one or more categorized scores to the documents. The better is the document statistic data, the greater score can be assigned to the document. For example, users make 1000 and 30000 average daily and monthly visits, respectively, of document www.domainforexample1.com/index.htm. Therefore, to this document can be added an additional weight comparing to another document (such as www.domainforexample2.com/index.htm having only 20 and 600 average daily and monthly visits, respectively), when assigning to it one or more categorized scores and/or when assigning to another document, being linked from said document or having at least one link to said document, one or more categorized scores.

According to a preferred embodiment of the present invention, a home page or directory page of each linking document can be analyzed for calculating and assigning one or more categorized scores to each document linked from said each linking document. This preferred embodiment does not allow Web sites webmasters to create false documents for exchanging links with other Web sites. For example, www.domainforexample1.com is the sport-related Web site, having a sport related home page: www.domainforexample1.com/index.htm. The webmaster of this Web site decides to exchange links with other Web sites, such as movies, music, education-related Web sites. He creates a number of link pages, for example, www.domainforexample1.com/education.htm and www.domainforexample1.com/movies.htm pages and place at these page education and movies related links, respectively. Since the home page of this Web site is sport-related, then by analyzing and determining that it is sport-related, all forward links from said www.domainforexample1.com/education.htm and www.domainforexample1.com/movies.htm pages would not be considered (or would partially considered) by the search engine provider for assigning one or more categorized scores to the corresponding one or more linked documents. In addition, according to this preferred embodiment of the present invention, for assigning one or more categorized scores to the linked document can be analyzed one or more parameters of each link form one or more linking documents to said linked document, and/or can be analyzed linking document parameters, and/or can be analyzed the linked document parameters. Also, if it is determined that the linking page, such as www.domainforexample1.com/education.htm is not related to the home or directory page, such as www.domainforexample1.com/index.htm, then a link from said linking page to the linked page can be still considered for assigning one or more categorized scores to said linked page. For example, suppose that document www.domainforexample1.com/education.htm (having a number of links to other documents) is analyzed and is determined that it is education-related document, comprising educational articles. Suppose that www.domainforexample1.com/index.htm home page is sport-related. Then the search engine provider, by analyzing said home page, and determining, for example, that it contains one or more educational words, can still give some weight to one or more links from said education related page www.domainforexample1.com/education.htm, considering said links for assigning one or more categorized scores to the linked page. The analyzing of said home or directory page one or more parameters is similar to analyzing linking or linked documents one or more parameters, and is similar to analyzing one or more parameters of a link from each linking document to each linked document. Analyzing parameters comprises analyzing anchor text, wording, URL data, creation or update data (such as creation or update date and time, author, etc.), statistic data (such as a number of average daily and monthly visits), users' votes, etc.

According to another preferred embodiment of the present invention, each linking and/or linked document is analyzed in order to determine its history data for assigning to said each linked document one or more categorized scores. The history data of each linking and/or linked document comprises: (a) content(s) update(s) or change(s); (b) creation date(s); (c) ranking history; (d) categorized ranking history; (e) traffic data history; (f) query(is) analysis history; (g) unique word(s) usage history, (h) URL data history; (i) user behavior history; (j) user maintained or generated data history; (k) phrase(s) in anchor text usage history; (l) linkage of an independent peer(s) history; (m) anchor text content(s) history; (n) document topic(s) history; (o) meta data history; (p) bigram(s) history; and etc.

According to another preferred embodiment of the present invention, each linking and/or linked document is analyzed in order to determine a probability for assigning to said linked document greater or smaller one or more categorized scores (comparing to the current one or more categorized scores), said probability is determined, for example, by basing on the linked document history and/or basing on the linked document statistic data and/or basing on the linked documents users' votes for one or more categories of said linked document.

According to a preferred embodiment of the present invention, if the search engine provider can not determine a category of a linked and/or linking document, then are analyzed and/or categorized one or more parameters of links from or to said linked and/or linking document, respectively. Then said linked and/or linking document can be categorized according to said analyzing of said one or more links parameters. According to another preferred embodiment of the present invention, if the search engine provider can not determine a category of a linked document then are analyzed one or more parameters of the corresponding at least one linking document. If the search engine provider can not determine a category of a linking document then are analyzed one or more parameters of the corresponding at least one linked document.

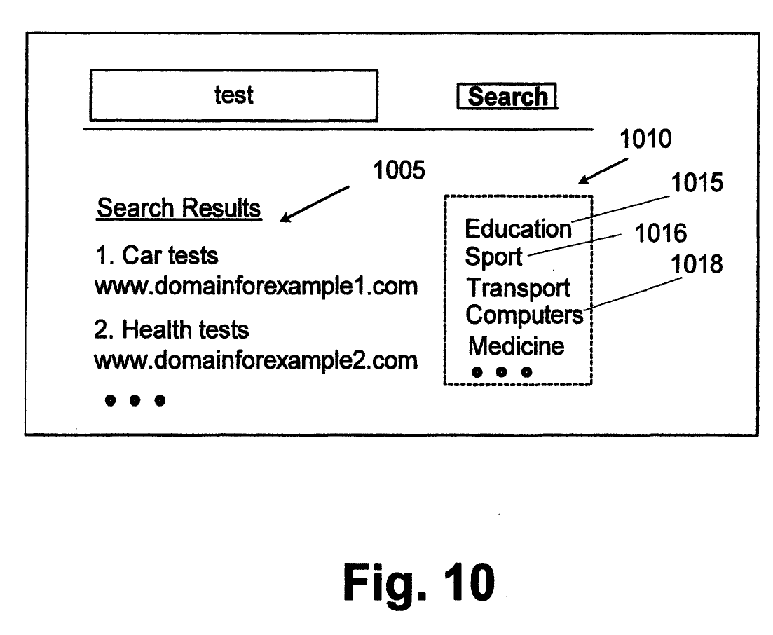

FIG. 10 is a schematic illustration of conducting a search over a data network, when using one or more search keywords that relate to more than one category, according to a preferred embodiment of the present invention When a user searches the Web by using, for example, a keyword “test”, he can be interested in a variety of different tests, such as a “car test”, in a “computer test”, in a “health test”, etc. Thus, the user can be provided with a list of search results 1005 related to all existing tests. The user can be able to select one or more narrower categories for conducting a narrower search or for narrowing the received list of search results 1005 to be related only to said one or more narrower categories. By selecting, for example, a Computers category 1018, the user can further search only computer-related sites. Also, by selecting said Computers category 1018, the list of search results 1005 is limited only to search results related to Computers. Thus, the unrelated sites are eliminated, enabling the user to receive more accurate search results that are more related to what he wishes to find. It should be noted that the user can select one or more corresponding categories (or sub-categories), within which he wishes to conduct a search, prior to conducting a search. After he conducts a search, he can limit the received list of search results by selecting narrower sub-categories. For example, after conducting a search within the Sport category 1016 by selecting said category prior to conducting the search, and using a keyword “ball”, the user can narrow his search by selecting a narrower sub-category, such as the football, basketball, etc.

It should be noted that the narrower are categories 1010 that are presented to the user, the more accurate search results said user can receive by selecting one or more of said categories. After selecting, for example, Education category 1015, the user can be presented with narrower Education-related sub-categories, such as a “university”, “school”, “college”, etc. for searching in narrower Education-related sites. After selecting one of the above sub-categories (e.g., “university”), the user can be further presented with sub-categories that are narrower than “university” (such as “undergraduate studies”, “graduate studies”, etc.) and so on. Thus, the number of eliminated Web sites that are not related to what the user wishes to find, can be increased as much as possible. After narrowing each time a number of Education-related sites, the user can be provided with narrower sub-categories until he finally decides that his search results 1005 are narrow enough.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A method of enabling voting for a document stored within a database over a data network, comprising:
a. receiving user's search query;
b. providing a search results list, according to said search query, wherein said search results list comprises at least one document;
c. providing one or more categorized voting scales for said at least one document, said one or more voting scales enabling selecting corresponding one or more categorized evaluations for said at least document, thereby enabling providing one or more categorized votes for said at least one document; and
d. submitting said one or more categorized evaluations.

2. Method according to claim 1, further comprising receiving the one or more categorized evaluations of the at least one document.

3. Method according to claim 1, further comprising providing the at least one document with one or more categorized scores.

4. Method according to claim 3, further comprising updating the one or more categorized scores of the at least one document.

5. Method according to claim 4, further comprising decreasing the categorized score of the document, if the corresponding categorized evaluation is negative.

6. Method according to claim 4, further comprising increasing the categorized score of the document, if the corresponding categorized evaluation is positive.

7. Method according to claim 1, further comprising providing the one or more categorized voting scales within the at least one document.

8. Method according to claim 1, further comprising providing the one or more categorized voting scales within the search results list.

9. A method of enabling voting for a document stored within a database over a data network, comprising:
a. embedding within a document the corresponding program code that enables providing and displaying at least one categorized voting scale when opening said document, said at least one categorized voting scale comprising one or more categorized evaluations of said document; and
b. voting for said document by selecting at least one categorized evaluation from said one or more categorized evaluations, and submitting the selected at least one categorized evaluation.

10. Method according to claim 9, further comprising receiving the submitted at least one categorized evaluation.

11. Method according to claim 9, further comprising providing the document with one or more categorized scores.

12. Method according to claim 11, further comprising updating the one or more categorized scores of the document.

13. Method according to claim 9, further comprising providing the at least one categorized voting scale within the document.

14. A computer readable recording medium configured to store a set of executable instructions for voting for a document stored within a database over a data network, comprising:
a. one or more instructions for receiving user's search query;
b. one or more instructions for providing a search results list, according to said search query, wherein said search results list comprises at least one document;
c. one or more instructions for providing one or more categorized voting scales for said at least one document, said one or more voting scales enabling selecting corresponding one or more categorized evaluations for said at least document, thereby enabling providing one or more categorized votes for said at least one document; and
d. one or more instructions for submitting said one or more categorized evaluations.

15. Computer readable recording medium according to claim 14, further comprising one or more instructions for receiving the one or more categorized evaluations of the at least one document.

16. Computer readable recording medium according to claim 14, further comprising one or more instructions for providing the at least one document with one or more categorized scores.

17. Computer readable recording medium according to claim 16, further comprising one or more instructions for updating the one or more categorized scores of the at least one document.

18. Computer readable recording medium according to claim 14, further comprising one or more instructions for providing the one or more categorized voting scales within the at least one document.

19. Computer readable recording medium according to claim 14, further comprising one or more instructions for providing the one or more categorized voting scales within the search results list.

20. A computer readable recording medium configured to store a set of executable instructions for enabling voting for a document stored within a database over a data network, comprising:
a. one or more instructions for embedding within a document the corresponding program code that enables providing and displaying at least one categorized voting scale when opening said document, said at least one categorized voting scale comprising one or more categorized evaluations of said document; and
b. one or more instructions for voting for said document by selecting at least one categorized evaluation from said one or more categorized evaluations, and submitting the selected at least one categorized evaluation.
